(19) United States
(12) Patent Application Publication
(10) Pub. No.: US 2011/0296750 A1
(43) Pub. Date: Dec. 8, 2011

(54) ROLLING HERBICIDE APPLICATOR AND SHIELD

(76) Inventor: Ronnie Matthew Davis, Honea Path, SC (US)

(21) Appl. No.: 12/792,346

(22) Filed: Jun. 2, 2010

(51) Int. Cl. A01M 21/04; A01G 1/00

(52) U.S. Cl. 47/1.7; 47/58.1 R

(57) ABSTRACT

A rolling herbicide applicator contains an herbicide nozzle fastened to a rigid shaft and axle at the center of a rolling disc for selectively applying herbicide to undesirable plants, while shielding desirable plants from herbicide overspray. The rolling applicator allows a user to trace a flowing outline through landscape arrangements of any shape with a steady movement as the rolling disc proceeds along the outline. The open design simultaneously provides the operator a direct and continuous view of the sprayer in operation.

### FIELD OF THE INVENTION

The present invention relates to an apparatus and method for applying herbicide to select areas and, more specifically, to a rolling herbicide applicator for selectively applying herbicide to undesirable plants, while simultaneously shielding desirable plants from unintended overspray.

### BACKGROUND OF THE INVENTION

Landscaping and garden arrangements are becoming increasingly complex. Modern lawns often use a variety of plants alongside grass arranged in flowing lines so that it is frequently difficult to maintain the boundaries between different types of vegetation. It is even more difficult to apply herbicide to selected plants without inadvertently spraying desirable plants.

The system disclosed in U.S. Pat. No. 7,581,350 to Ram, for example, attempts to overcome the problem of overspray by disclosing an apparatus designed to encircle individual plants so as to protect those plants when applying herbicide. While useful in protecting specific plants, Ram does not provide a system for rapidly applying herbicide to select areas of vegetation arranged in flowing lines; nor does Ram provide a system for applying an herbicide while tracing a specific pattern as the operator walks along that pattern.

U.S. Patent Publication No. 2009/0294555 discloses a rolling herbicide applicator that uses a cylinder-shaped shroud to apply herbicide within the shroud as the operator proceeds along a given area. This design attempts to overcome some of the deficiencies in Ram, but still does not allow the operator to view the sprayer in operation. That is an important deficiency because the sprayer should be viewable while in use to allow the operator to view the area being sprayed in order to adjust the sprayer as needed during use. It is also important that the sprayer be viewable so that the operator knows, for example, when the sprayer is not working properly or when the herbicide level is low.

What is needed is a system that allows an operator to apply herbicide in a defined pattern as he walks along that pattern, but that simultaneously protects selected vegetation from overspray. What is also needed is a system that allows an operator to view operation of the herbicide nozzle as he walks along a variable pattern. What is also needed is a system that allows the operator to adjust the friction of a rolling applicator for applying herbicide.

Accordingly, an object of the present invention is to provide a rolling herbicide applicator that allows an operator to apply herbicide in a flowing or irregular pattern as he walks along that pattern, but that simultaneously protects selected vegetation from overspray.

Another object of the present invention is to provide a rolling herbicide applicator that allows an operator to view operation of the herbicide nozzle as he walks along a variable pattern.

Yet another object of the present invention is to provide a rolling applicator that allows the operator to adjust the friction of a rolling applicator for applying herbicide

### BRIEF DESCRIPTION OF THE INVENTION

The present invention accomplishes the foregoing objections by providing a rolling herbicide applicator for selectively applying herbicide to undesirable vegetation, while shielding desirable vegetation. The rolling herbicide applicator comprises: an L-shaped rigid shaft comprising an upright length designed for use substantially perpendicular to a ground surface and a parallel length designed for use substantially parallel to a ground surface; a disc carried by the shaft, wherein a rounded opening is provided at the center of the disc and wherein the distal end of the parallel length is inserted through the opening and held in place by a first connection means thereby allowing the disc to rotate about the parallel length; and a second connection means for attaching an herbicide sprayer substantially parallel to the perpendicular length, wherein herbicide may be delivered to a selected area adjacent to a corresponding side of the disc while the disc operates as a shield to prevent delivery of the herbicide to the opposing side of the disc.

The applicator may include a first connection means comprising a member at the distal end of the parallel length, whereby the member is compressible to facilitate insertion through the rounded opening of the disc.

The applicator may also include a first connection means comprising a threaded portion at the distal end of the parallel length and one or more threaded nuts, whereby the one or more threaded nuts are attached to the threaded portion.

The applicator may also include a first connection means adjustable to provide a variable amount of friction between the shaft and the disc.

The applicator may also include a first connection means adjustable to provide a variable distance between the disc and the upright length.

The applicator may also include a second connection means comprising adjustable fittings to attach varying sizes of herbicide sprayer nozzles.

The present invention also includes a method of using the rolling herbicide applicator comprising the steps of securing an herbicide sprayer to a rolling shield; placing said rolling shield in contact with a ground surface having undesirable vegetation; operating said herbicide sprayer to begin application of herbicide to said undesirable vegetation; proceeding along said ground surface, while maintaining said rolling shield in contact with said ground surface so that said rolling shield rotates about a shaft, whereby said herbicide is applied to said undesirable vegetation on a first side of said disc, while said rolling shield simultaneously shields desirable vegetation on a second side of said disc from said herbicide.

### BRIEF DESCRIPTION OF THE DRAWINGS

FIG. 1 illustrates a rolling herbicide applicator system according to the present invention.

FIG. 2A illustrates an herbicide applicator with a threaded shaft and two nuts to affix a rolling disc.

FIG. 2B illustrates an herbicide applicator with compressible attachment means to affix a rolling disc.

FIG. 2C illustrates an herbicide applicator with a threaded shaft and two nuts to affix a rolling disc and a small spray nozzle affixed to the sprayer shaft.

FIG. 2D illustrates an herbicide applicator with compressible attachment means to affix a rolling disc and a large spray nozzle affixed to the sprayer shaft.

FIG. 3 illustrates a rolling herbicide applicator in use to treat weed encroachment along a flowing path.

FIG. 4 illustrates a method of using a rolling herbicide applicator according to the present invention.

### DETAILED DESCRIPTION OF THE INVENTION

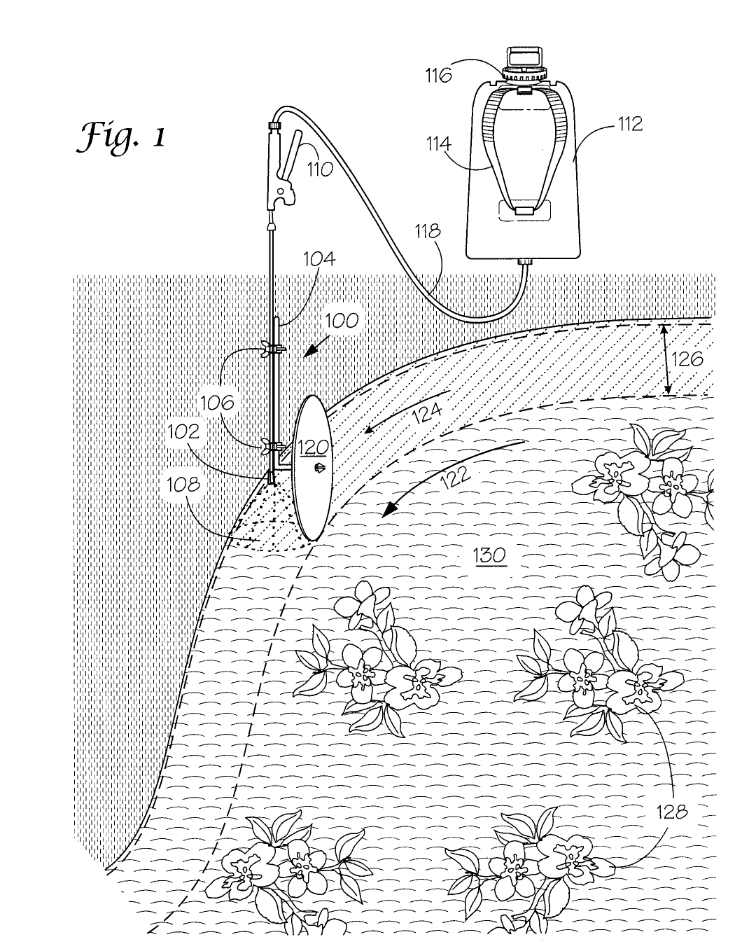

The present invention is directed to an apparatus and method of using a rolling herbicide applicator with integrated shield for selectively applying herbicide to undesirable vegetation, while shielding desirable vegetation. Referring now to FIG. 1, a rolling herbicide applicator system 100 according to the present invention is illustrated. System 100 allows an operator, such as a gardener or landscaping employee, to apply herbicide such as Roundup® to a designated area along a flowing or varied path in a manner that simultaneously protects desirable vegetation adjacent to the flowing path.

A standard herbicide spray nozzle 102 is affixed to shaft 104 using attachment means 106. The flow of herbicide is controllable through control valve 110 to apply herbicide in a desired spray pattern 108. Attachment means 106 is used to connect spray nozzle 102 to the shaft 104, which is preferably an L-shaped member. Preferably two or more adjustable clamps are used for attachment means 106 so that spray nozzle 102 may be accommodated in various sizes, such as the standard ¼ inch and ⅝ inch diameters nozzles.

Liquid herbicide is stored in reservoir 112, which is preferably maintained in a back-pack-style reservoir and worn on an operator's back using straps 114. An operator fills the herbicide reservoir 112 through filler cap 116. During use, liquid herbicide flows from reservoir 112, through delivery tube 118, through control valve 110, and ultimately out of the distal end of sprayer nozzle 102.

In a preferred embodiment, an operator (not shown) walks along a specified path 122 and rolls disc 120 along an edge parallel to that path so that herbicide may be delivered in an appropriate width 126. In this manner herbicide is delivered in an intended spray pattern 108 along spray path 124 so that proper application of the liquid herbicide will eliminate unwanted vegetation growing along spray path 124. At the same time, desirable plants 128 growing in area 130 on the opposite side of disc 120 are shielded from liquid herbicide overspray by disc 120. Spray path 124 is treated in this manner with a desired placement of herbicide, while area 130 is protected from inadvertent herbicide spray as desired.

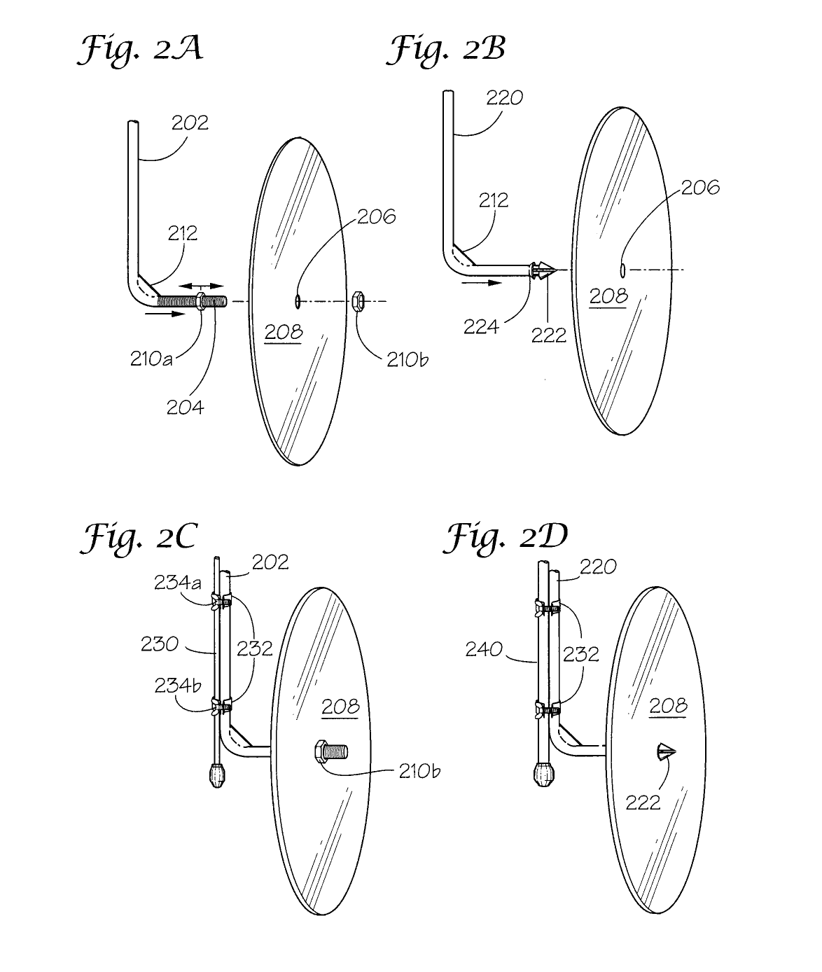

Referring now to FIG. 2A, an L-shaped shaft 202 is illustrated with a parallel length and perpendicular length. The parallel length is illustrated with a distal end threaded portion 204 designed for insertion through round opening 206 in the center of disc 208. In this embodiment, nut 210a is first placed along threaded portion 204 at the proper inside location. Distal end 204 is then inserted through opening 206 until disc 208 comes into contact with nut 210a. Nut 210b is then threaded onto the opposite side of disc 208 to hold disc 208 in the proper position along the parallel length. In a preferred embodiment, nut 210a and nut 210b are lock nuts to prevent loosening as disc 208 rotates about shaft 202 during use. Triangular reinforcement 212 may also be used to provide further reinforcement to shaft 202 in the 90 degree elbow portion thereof.

Referring now to FIG. 2B, L-shaped shaft 220 is provided with an alternate connection means 222 along a distal end of its parallel length. In this embodiment, a cone-shaped and slotted compressible member forms connection means 222 to hold disc 208 in the proper position along shaft 220. Connection means 222 is inserted through opening 206 in the direction indicated. The two ends of the compressible member in connection means 222 squeeze together to allow insertion through 206. When disc 208 is forced along shaft 220 to the proper position, where disc 208 comes into contact with tapered sleeve 224 located on the parallel length, the two ends of the compressible member in connection means 222 decompress and hold disc 208 in the proper position on shaft 220.

Referring now to FIG. 2C, L-shaped shaft 202 is illustrated securely fastened by nut 210a and nut 210b, which hold disc 208 substantially parallel to the perpendicular (generally upright) length of shaft 202. Herbicide nozzle 230 is affixed to the perpendicular length of shaft 202 by a second connection means 232. In this embodiment, second connection means 232 is provided by two metal or plastic bands fastened by butterfly screws 234a and 234b. Use of butterfly screws 234a and 234b provide a simple connection means that is also easily adjustable to accommodate different diameter nozzles 230. Once nozzle 230 is placed along the perpendicular length of shaft 202 as illustrated, butterfly lock nuts 234a and 234b are tightened to hold nozzle 230 securely in place along shaft 202.

The second connection means 232 can also be any number of other well known devices, such as pipe clamps. It is even possible that the second connection means may be disposable tie wraps that incorporate the needed holding strength, variable length, and ease of use. This variable mode of attachment allows the invention to accommodate multiple nozzle sizes and diameters. For example, the herbicide nozzle 240 illustrated in FIG. 2D is substantially larger than nozzle 230 in FIG. 2C, but both are connected using the same type of second connection means 232. Preferably, second connection means 232 offers the flexibility of accommodating a wide range of herbicide nozzles as needed. This flexibility is important because gardeners and other intended users generally keep multiple types of herbicide in multiple containers that employ multiple types and sizes of nozzles.

The first connection means illustrated as nuts 210a and 201b in FIG. 2A and compressible member 222 in FIG. 2B, respectively, may also be configured to provide adjustability of friction in the turning of disc 208, as well as the distance disc 208 is set from the perpendicular portion of shaft 202. In the embodiment illustrated in FIG. 2C, nuts 210a and 210b are provided to incorporate these important aspects of the invention. More specifically, nut 210a may be tightened or loosened in conjunction with nut 210b to increase or decrease the rolling resistance of disc 208. This may be desirable to increase or decrease the required downward force applied to shaft 202 in order to hold disc 208 in place along a desired pathway. If the surface of the desired pathway is slippery, for example, it may be desirable to decrease the rolling resistance of disc 208 by loosening nut 210a or 210b.

The placement of nuts 210a and 210b along threaded portion 204 of the parallel length is also adjustable to increase or decrease the width of a desired herbicide spray pattern. The spray pattern width 126 illustrated in FIG. 1, for example, may be easily varied by moving nuts 210a and 210b closer to or further from spray nozzle 230 as illustrated in FIG. 2C. The distance of rolling disc 208 from nozzle 230 is varied in this manner so that the simultaneous shield effect provided by disc 208 can be widened or narrowed.

By contrast, the first connection means of FIG. 2D does not provide the same adjustability, but instead provides a quicker connection and disconnection means for disc 208. This embodiment may be more desirable if the operator intends to use different sizes or types of disc 208 for different applications.

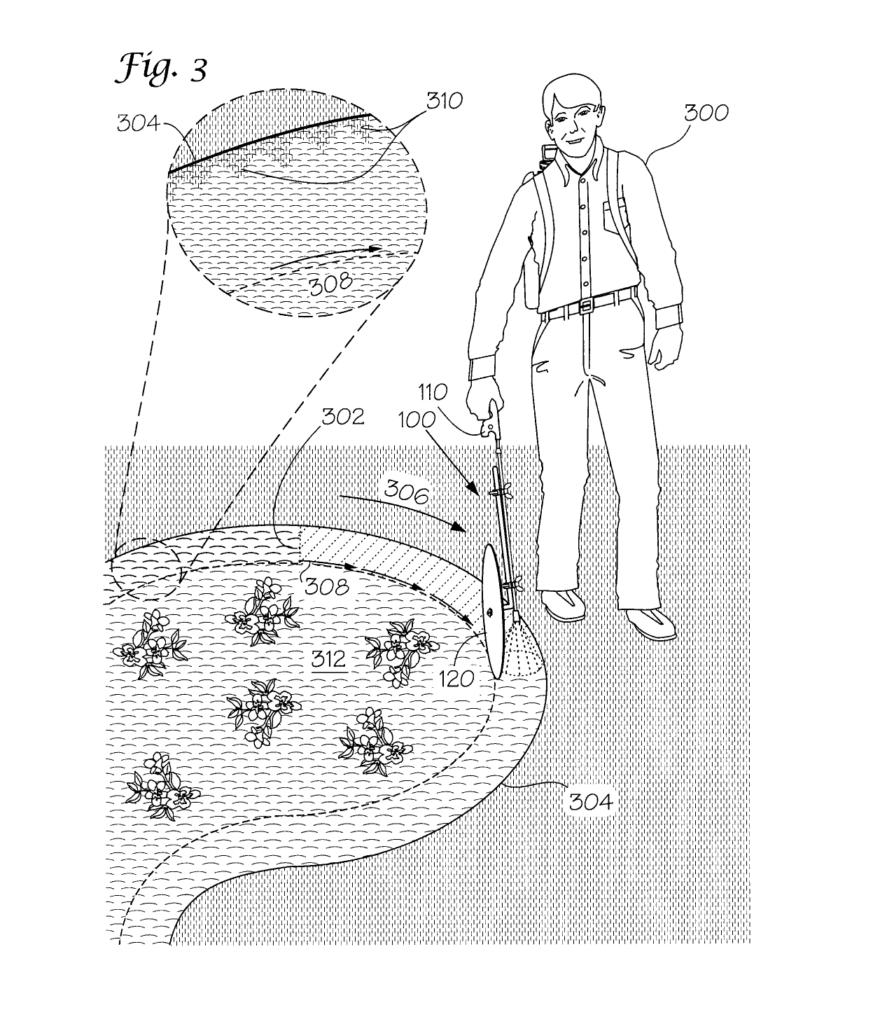

Referring now to FIG. 3, operator 300 is illustrated using a rolling herbicide applicator system 100 according to an embodiment of the present invention. Area 312 is illustrated with a mulch covering that is suffering from unwanted encroachment of grass 310 past boundary 304. Operator 300 is illustrated using rolling herbicide applicator 100 to apply herbicide directly to the encroaching grass 310.

Operator 300 begins the process by placing disk 120 of applicator 100 directly onto pathway 308 at starting point 302. Operator 300 then operates control valve 110 to begin the flow of herbicide as he simultaneously proceeds along pathway 306, which pathway is roughly parallel to boundary 304. As operator 300 walks along pathway 306, he endeavors to follow boundary 304 by maintaining direct contact of disc 120 on pathway 308, which is directly parallel to boundary 304, so that disc 120 rolls along parallel pathway 308. Herbicide flows as illustrated into a designated area just inside boundary 304. In this manner the weed encroachment 310 indicated just inside of boundary 304 is sprayed with herbicide, while desirable vegetation in area 312 is shielded from overspray by disc 120.

The above is possible for many reasons related to the design of the invention. For example, the design of rolling disc 120 allows operator 300 to follow a flowing path with precision. Rolling disc 120 also simultaneously prevents overspray because its round shape provides a sufficient physical barrier.

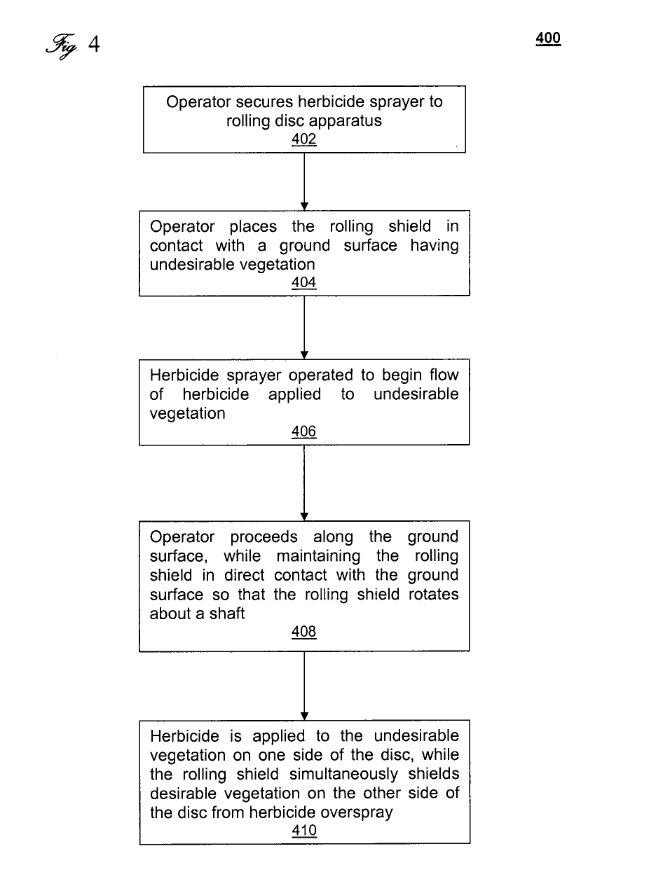

Referring now to FIG. 4, a method is illustrated for using an embodiment of the invention to apply herbicide to undesirable vegetation while simultaneously shielding desirable vegetation. An operator, such as operator 300, secures an herbicide sprayer to a rolling shield at step 402. A standard herbicide sprayer, such as those illustrated in FIGS. 1 and 3 is preferable.

The operator at step 404 then places the rolling shield in contact with a ground surface having undesirable vegetation. Once properly placed, the herbicide sprayer is operated at step 406 to begin application of herbicide to undesirable vegetation, which should be directly beneath the herbicide sprayer. This is illustrated in perhaps more detail with respect to FIG. 3.

The operator then proceeds along the ground surface at step 408, while maintaining the rolling shield in direct contact with the ground surface so that the rolling shield rotates about a shaft. Herbicide is applied as desired in step 410, whereby the herbicide is applied to the undesirable vegetation on one side of the disc, while the rolling shield simultaneously shields desirable vegetation on the other side of the disc from herbicide overspray.

These illustrated examples are, however, offered by way of illustration of the invention's versatility and not meant to limit the invention in any way. The present invention may be embodied in other specific forms without departing from its spirit of essential characteristics. The described embodiments are to be considered in all respects only illustrative and not restrictive. The scope of the invention is therefore indicated by the appended claims rather than by the foregoing description. All changes which come within the meaning and scope of equivalency of the claims are to be embraced within their scope.

What is claimed is:

1. A rolling herbicide applicator for selectively applying herbicide to undesirable vegetation, while shielding desirable vegetation, the applicator comprising:
an L-shaped rigid shaft comprising an upright length and a parallel length;
a disc carried by said shaft, wherein a rounded opening is provided at the center of said disc and wherein a distal end of said parallel length extends through said opening and is held in place by a first connection means, thereby allowing said disc to rotate about said parallel length; and
a second connection means for attaching an herbicide sprayer substantially parallel to said perpendicular length, wherein herbicide may be delivered to a selected area adjacent to a corresponding side of said disc, while said disc operates as a shield to prevent delivery of said herbicide to an opposing side of said disc.

2. The applicator according to claim 1 wherein said first connection means comprises a member at said distal end of said parallel length, whereby said member is compressible to facilitate insertion through said rounded opening.

3. The applicator according to claim 1 wherein said first connection means comprises a threaded portion at said distal end of said parallel length and one or more threaded nuts, whereby said one or more threaded nuts are attached to said threaded portion.

4. The applicator according to claim 1 wherein said first connection means is adjustable to provide a variable amount of friction between said shaft and said disc.

5. The applicator according to claim 1 wherein said first connection means is adjustable to provide a variable distance between said disc and said upright length.

6. The applicator according to claim 1 wherein said second connection means is adjustable to connect multiple sizes of said herbicide sprayer nozzles.

7. A method of applying herbicide to undesirable vegetation while simultaneously shielding desirable vegetation, the method comprising the steps of:
securing an herbicide sprayer to a rolling shield;
placing said rolling shield in contact with a ground surface having undesirable vegetation;
operating said herbicide sprayer to begin application of herbicide to said undesirable vegetation;
proceeding along said ground surface, while maintaining said rolling shield in contact with said ground surface so that said rolling shield rotates about a shaft, whereby said herbicide is applied to said undesirable vegetation on a first side of said rolling shield, while said rolling shield simultaneously shields desirable vegetation on a second side of said rolling shield from said herbicide.

8. A method of applying herbicide to undesirable vegetation while simultaneously shielding desirable vegetation, the method comprising the steps of:
securing an herbicide sprayer to a rolling shield, said rolling shield comprising a disc carried by an L-shaped rigid shaft, wherein a rounded opening is provided at the center of said disc and wherein a distal end of said shaft extends through said opening, thereby allowing said disc to rotate about said shaft;
placing said rolling shield in contact with a ground surface having undesirable vegetation;
operating said herbicide sprayer to begin application of herbicide to said undesirable vegetation;
proceeding along said ground surface, while maintaining said rolling shield in contact with said ground surface so that said rolling shield rotates about said shaft;
whereby said herbicide is applied to said undesirable vegetation on a first side of said disc, while said rolling shield simultaneously shields desirable vegetation on a second side of said disc from said herbicide.
